(19) United States
(12) Patent Application Publication
(10) Pub. No.: US 2020/0339213 A1
(43) Pub. Date: Oct. 29, 2020

(54) HOLLOW CYLINDRICAL COMPONENT AND STEM FOR A BICYCLE, AND BICYCLE

(71) Applicant: MYSTROMER AG, Oberwangen b. Bem (CH)

(72) Inventors: Andreas ZBÄREN, Herbligen (CH); Roger BUCHS, Liebistorf (CH); Peter EGLI, Münchenbuchsee (CH)

(21) Appl. No.: 16/642,917

(22) PCT Filed: Aug. 28, 2018
(86) PCT No.: PCT/IB2018/056554

§ 371 Date: Feb. 28, 2020

(30) Foreign Application Priority Data
Aug. 29, 2017 (CH) 01068/17

(51) Int. Cl. B62K 19/32

(52) U.S. Cl. CPC B62K 19/32; B62K 13/08

(57) ABSTRACT

Disclosed are a hollow cylindrical component for a bicycle, a stem having a hollow cylindrical component for a bicycle, and a bicycle having a hollow cylindrical component or a stem. To allow lines of the bicycle to be installed in a simple, secure, and protected manner, the hollow cylindrical component has at least one line receptacle in the cylinder wall thereof.

### TECHNICAL FIELD

The present invention relates to the field of bicycles that may be driven electrically and/or by muscle power, and electric motorcycles, also pedelecs or E-bikes, referred to below as bicycles for the sake of simplicity. The invention relates to a hollow cylindrical component for a bicycle, having a cylinder wall that separates the inner cavity of the hollow cylindrical component from the surroundings of the hollow cylindrical component. The invention further relates to a stem for a bicycle that has a hollow cylindrical component. The invention further relates to a bicycle.

### TECHNOLOGICAL BACKGROUND

Bicycles use lines for relaying operating signals of operating elements, for example to a circuit, to a brake, and/or to a drive motor, and to associated electronic controllers and/or to the rechargeable battery of the electric bicycle.

These lines are often laid outside the frame of the bicycle; not only does this have an unsightly appearance, but in addition the rider of the bicycle or his/her clothing, or objects along a route being traveled by the bicycle, may get caught in these lines, thus increasing the risk of an accident.

In addition, lines extending outside the frame are exposed to weather influences and mechanical effects with relatively little protection, which may result in corrosion and damage of the lines.

To allow the lines to be laid inside the frame of the bicycle, WO 2015/180756 A1, for example, discloses a steerer tube having a recess that provides room for laying a line between the steerer tube receptacle of the bicycle and the steerer tube itself. However, in order to replace the fork of the bicycle with another fork, it is necessary to once again use a fork having the specially shaped steerer tube. As a result, the options for individually adapting and repairing the bicycle are limited.

### SUMMARY OF THE INVENTION

The object of the invention is to provide a hollow cylindrical component for a bicycle, a stem for a bicycle, and/or a bicycle, wherein the bicycle may be easily adapted to individual needs and repaired, and at the same time meets high esthetic demands and complies with safety standards.

This object is achieved by a hollow cylindrical component according to the invention, wherein the hollow cylindrical component has at least one line receptacle that extends, at least in sections, along the longitudinal axis of the hollow cylindrical component and is at least partially situated in the cylinder wall. This object is further achieved by a stem according to the invention for a bicycle, wherein the hollow cylindrical component of the stem is the hollow cylindrical component according to the invention. Moreover, the object is achieved by a bicycle according to the invention, wherein the bicycle has a hollow cylindrical component according to the invention and/or a stem according to the invention.

As a result of the at least one line receptacle being situated in the cylinder wall, lines may be laid inside the component, it being possible to use any desired elements, which in particular are standardized and engage in the inner cavity of the hollow cylindrical component, together with the hollow cylindrical component. The hollow cylindrical component is insertable, for example, as a type of socket, into the stem of a bicycle, for example, in order to provide the line receptacle at that location. The hollow cylindrical component may thus also be regarded as a stem socket, but may also be used as a bearing bush at other locations, for example on a bottom bracket, to allow lines to be laid at that location.

The approach to achieving the object may be further enhanced by various embodiments, each advantageous in itself, and if not stated otherwise, arbitrarily combinable with one another. These embodiments and their associated advantages are discussed below.

According to a first further embodiment, the line receptacle is formed at a distance from the outer casing of the hollow cylindrical component. Outside influences and, for example, collisions of the hollow cylindrical component with external elements, such as when the bicycle is traveling through a forest and branches strike the hollow cylindrical component, therefore have little influence on the hollow cylindrical component, since the thickness of the cylinder wall, due to the distance of the line receptacle from the outer casing, easily corresponds to a minimum thickness, and the mechanical stability of the hollow cylindrical component, also in the area of the line receptacle, is not greatly impaired. However, the line accommodated in the line receptacle is protected by the cylinder wall from possible external influences.

According to one embodiment, the line receptacle is completely enclosed by the material of the cylinder wall transverse to the longitudinal axis of the hollow cylindrical component, so that a line in the line receptacle transverse to the longitudinal axis is protected on all sides from mechanical influences.

In another embodiment, the line receptacle, at least in sections, is open toward the inner cavity of the hollow cylindrical component, so that a line may be easily inserted into the line receptacle. The line receptacle, at least in sections, may thus be designed as a groove that is open toward the inner cavity, and whose longitudinal axis extends along the outer casing and/or in parallel to the longitudinal axis of the hollow cylindrical component.

According to a first further embodiment, the line receptacle is formed at a distance from the inner casing of the hollow cylindrical component, so that lines may be easily inserted into the line receptacle from the outside.

So that elements that engage in the inner cavity result in little or no mechanical impairment of a line situated in the line receptacle, even when they extend through an end opening of the hollow cylindrical component, according to one embodiment the at least one line receptacle extends through an end-face side of the hollow cylindrical component. The end-face side encloses the end opening, for example transversely with respect to the longitudinal axis of the hollow cylindrical component. As a result, the line and the element situated in the inner cavity may extend out of the hollow cylindrical component along the longitudinal axis without mechanically disturbing the element and the line.

In order to guide the line through the end-face side in the area of the end-face side without edges, which could damage the line during operation, according to one embodiment, in the area of the end-face side the at least one line receptacle curves away from the inner cavity and/or the longitudinal axis, or toward the cavity and/or the longitudinal axis.

According to one embodiment, the hollow cylindrical component has multiple line receptacles that are offset in parallel to one another, at least in sections. In this way, multiple lines may be securely situated in the line receptacles with little mechanical effort.

According to another embodiment, in the area of the end-face side the line receptacles are curved away from one another or toward one another. Even when the lines are to extend unguided outside the hollow cylindrical component, the line receptacles curving away from one another or toward one another specify different directions, pointing away from one another or toward one another, in which the lines extend outside the hollow cylindrical component, so that it is difficult for the lines to become tangled with one another or with other objects such as other lines.

When the hollow cylindrical component is the hollow cylindrical component of the stem for a bicycle, according to one embodiment the stem has a tube receptacle for accommodating a steerer tube by clamping or via a force-fit and/or form-fit connection. The hollow cylindrical component forms at least one section of the tube receptacle, and the inner cavity is designed to accommodate at least one section of the steerer tube. A large number of lines that extend from the handlebars into other areas of the bicycle are situated in the area of the handlebars of the bicycle. Selected lines, or all of these lines, may extend, at least in sections, through the at least one line receptacle or through the multiple line receptacles in order to guide the lines with the proper arrangement and protect them from collisions.

According to one embodiment, the tube receptacle is designed to accommodate the steerer tube in a receiving direction. The at least one line receptacle extends, at least in sections, along the receiving direction. For example, the longitudinal axis and the receiving direction extend in parallel to one another, so that the steerer tube and the at least one line have a design that is easily insertable into the hollow cylindrical component along the same direction.

According to one embodiment, the stem has a cavity for an electronic component, with the at least one line receptacle opening into the cavity. Electrical, optical, or other signal lines extending to the electronic component are thus easily connectable to the electronic component.

According to one embodiment, the stem has two handlebar connecting pieces for connection to handlebar grips for the bicycle. At least one of the handlebar connecting pieces is designed with at least one line guide that is situated, at least in sections, inside the handlebar connecting piece. The line guide opens into the cavity. Since operating elements, for example brake elements, switch elements, or other elements for controlling a drive motor of the bicycle are often situated in particular in the area of the handlebar grips, signal lines that are guided away from these operating elements may be led inside the stem. The operating elements or selected operating elements may be formed, for example, as operating levers, control buttons, control rings, or in some other way.

To allow the cavity to be kept preferably small and the signal lines preferably short, the cavity, at least in sections, is situated between the opening in the at least one line receptacle and the opening in the at least one line guide.

According to one embodiment, an electronic component is situated in the cavity, the electronic component being a signal distribution device for distributing control signals of a bicycle that is at least partially electrically operable or drivable.

According to one exemplary embodiment, the bicycle is a bicycle that is at least partially electrically operable or drivable. The bicycle may thus be a bicycle that is drivable solely by electrical power, solely by muscle power, or selectively by either electrical power or muscle power. In addition, the bicycle may be designed as an electric motorcycle, or also a pedelec or E-bike (electric bicycle).

According to one embodiment, the bicycle has a bicycle frame with at least one tubular section, the hollow cylindrical component or the stem being at least partially situated in the tubular section or forming same. Bicycle frames having tubular sections are widely used, so that specially adapted bicycle frames are not absolutely necessary for insertion of the hollow cylindrical component and/or the stem.

According to one embodiment, the tubular section cooperates with the hollow cylindrical component, includes same, or is made up of same. The tubular section of the bicycle is, for example, the head tube, the top tube, the down tube, the seat tube, the upper tube of the rear assembly, or the lower tube of the rear assembly of the bicycle frame. The hollow cylindrical component and/or the stem may thus be easily inserted or retrofitted, or integrated into the bicycle frame.

According to one embodiment, the hollow cylindrical component, as a socket element or a clamping sleeve, for example as part of the stem, is advantageously used for cable routing. As part of the stem, the hollow cylindrical component encloses the head tube, or is enclosed by the head tube or accommodated therein. The hollow cylindrical component may thus easily replace a different hollow cylindrical component, or the stem may easily replace a different stem. An inner shape or contour of the hollow cylindrical component may correspond to an outer shape or contour of the steerer tube. An outer shape or contour of the stem may correspond to an outer shape or contour of the head tube.

According to one embodiment, the hollow cylindrical component is connected in a motion-transmitting manner to a bicycle fork for the bicycle, and for example clamped to a steerer tube of the bicycle fork, wherein the steerer tube, at least in sections, for example extends through the hollow cylindrical component and is held by same by clamping or via a form-fit and/or force-fit connection. The hollow cylindrical component may thus be used for transmitting a steering force or a steering torque for steering the bicycle, wherein lines and, for example, brake lines leading to the front wheel of the bicycle are guided unseen through the line receptacles and/or protected, even when the hollow cylindrical component is moved relative to other elements of the bicycle frame and with respect to the tubular section, for example, in which the hollow cylindrical component may be situated.

According to one embodiment, the hollow cylindrical component has a slot that extends on one side of the longitudinal axis of the hollow cylindrical component, through the cylinder wall thereof. The slot extends in parallel or at an angle to the longitudinal axis. For example, the hollow cylindrical component forms at least one section of a tube receptacle. The tube receptacle is formed for the clamping accommodation of a tube, in particular a steerer tube or a seat tube, or as a further alternative, as a crankshaft or some other drive shaft. The inner cavity may be formed, at least in sections, in a receptacle in the tube. At least the portion of the hollow cylindrical component that forms the tube receptacle may be movably held in the tubular section.

In each of the preceding embodiments, the hollow cylindrical component, the stem, and/or the bicycle may have at least one, two, three, five, or up to 10, i.e., multiple or any desired number of, line receptacles, of which at least some are at least partially situated inside the cylinder wall and are optionally open toward the inner cavity, at least in sections. It is thus possible for only one line to be situated in a line receptacle in each case, so that the lines may be easily laid.

The lines are preferably signal lines that conduct control signals. The signal lines may be mechanical signal lines, such as Bowden cables, hydraulic or pneumatic signal lines, or electrical signal lines or optical signal lines.

Within the scope of the present disclosure, a cylinder is a body with an arbitrarily shaped base area. The body results from displacement of this base area along the longitudinal axis of the cylinder. The longitudinal axis may be oriented perpendicularly or at an angle, which is larger or smaller than 90°, with respect to the base area. In particular, the base area may have an essentially polygonal, oval, or ring shape. The cylinder has an outer casing that is directed away from the longitudinal axis. If the cylinder is designed as a hollow cylinder, the cylinder has an inner casing that adjoins the inner cavity of the cylinder and that may point to the longitudinal axis.

### BRIEF DESCRIPTION OF THE DRAWINGS

Reference is made below to the drawings for better understanding of the present invention. The drawings show exemplary embodiments of the inventive subject matter strictly by way of example.

Identical or functionally equivalent parts in the figures and the associated description are provided with the same or similar reference numerals.

FIG. 1 schematically shows a first possible exemplary embodiment of a hollow cylindrical component according to the invention in a cross-sectional illustration,

FIG. 2 shows a schematic cross-sectional illustration of another possible exemplary embodiment of a hollow cylindrical component according to the invention,

FIG. 3 schematically shows another possible exemplary embodiment of a hollow cylindrical component according to the invention in a cross-sectional illustration,

FIG. 4 shows a schematic cross-sectional illustration of yet another possible exemplary embodiment of the hollow cylindrical component according to the invention,

FIG. 5 schematically shows a first possible exemplary embodiment of a hollow cylindrical component according to the invention in a cross-sectional illustration,

FIG. 6 shows a schematic cross-sectional illustration of another possible exemplary embodiment of a hollow cylindrical component according to the invention,

FIG. 7 schematically shows yet another possible exemplary embodiment of a hollow cylindrical component according to the invention in a cross-sectional illustration,

FIG. 8 shows a schematic cross-sectional illustration of yet another possible exemplary embodiment of the hollow cylindrical component according to the invention,

FIG. 9 shows a schematic perspective view of one possible exemplary embodiment of a stem according to the invention for a bicycle,

FIG. 10 shows a schematic sectional illustration of the exemplary embodiment in FIG. 5, and

FIG. 11 shows a schematic view of a bicycle according to the invention.

### APPROACHES TO CARRYING OUT THE INVENTION

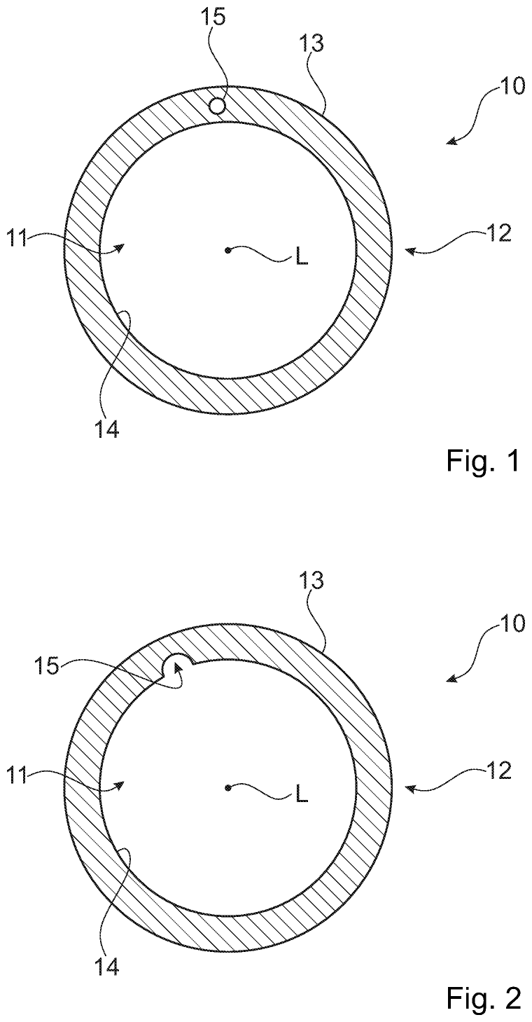

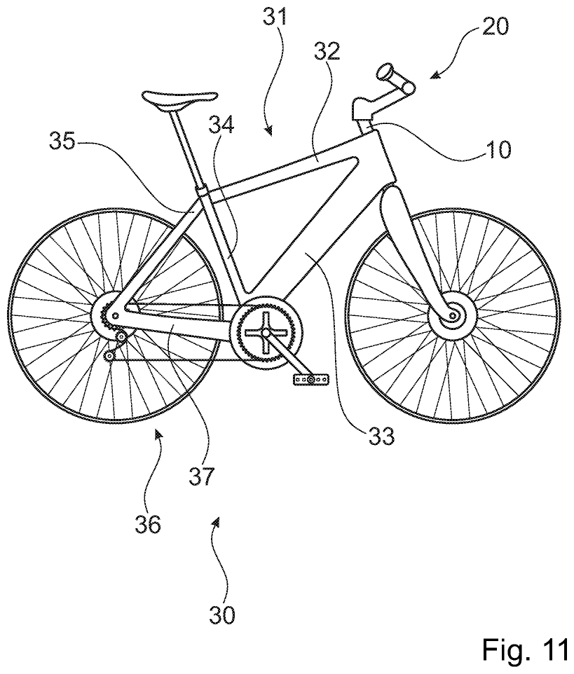

A first possible exemplary embodiment of a hollow cylindrical component 10 according to the invention for a bicycle (see FIG. 11) is illustrated in FIG. 1. The hollow cylindrical component 10 has an inner cavity 11 that is enclosed, at least in sections, by a cylinder wall 12 transverse to a longitudinal axis L of the hollow cylindrical component 10. The cylinder wall 12 has an outer casing 13 that faces away from the longitudinal axis L. In addition, the cylinder wall 12 has an inner casing 14 that faces the longitudinal axis L.

Between the outer casing 13 and the inner casing 14, the hollow cylindrical component 10 is provided with a line receptacle 15 that is spaced apart at least from the outer casing 13, and in the exemplary embodiment in FIG. 1, also spaced apart from the inner casing 14. The line receptacle 15 is thus situated inside the cylinder wall 12. Consequently, the line receptacle 15 is protected from mechanical impairment by the outer casing 13 and also by the inner casing 14. The line receptacle 15, at least in sections, extends in parallel to the longitudinal axis L.

FIG. 2 shows another possible exemplary embodiment of the hollow cylindrical component 10 according to the invention. For the sake of brevity, the following discussion addresses only the differences from the exemplary embodiment in FIG. 1. The line receptacle 15 of the hollow cylindrical component 10 in the exemplary embodiment illustrated in FIG. 2 is once again spaced apart from the outer casing 13. However, the line receptacle 15 in the exemplary embodiment in FIG. 2 penetrates the inner casing 14, at least in sections, so that the line receptacle 15, at least in sections, is open toward the inner cavity 11 and the longitudinal axis L. As a result, a line may be easily inserted, transversely with respect to the longitudinal axis L, into the line receptacle 15, which extends along the outer casing 13 in the manner of a groove.

An edge of the line receptacle 15 that is formed by the cylinder wall 12 may have a circular or polygonal base area in the base area of the hollow cylindrical component 10. In a plane transverse to the longitudinal axis L, the edge may extend over at least 90°, and for example up to 135°, up to 180°, or even up to 215°, about a midpoint of the circular or polygonal base area of the line receptacle 15. If the edge extends over less than 180°, a line may be easily inserted into the line receptacle 15. If the edge extends over more than 180°, the line may be held in the line receptacle 15 in a form-fit or force-fit manner with a cross section that is essentially complementary to the cross section of the line receptacle 15.

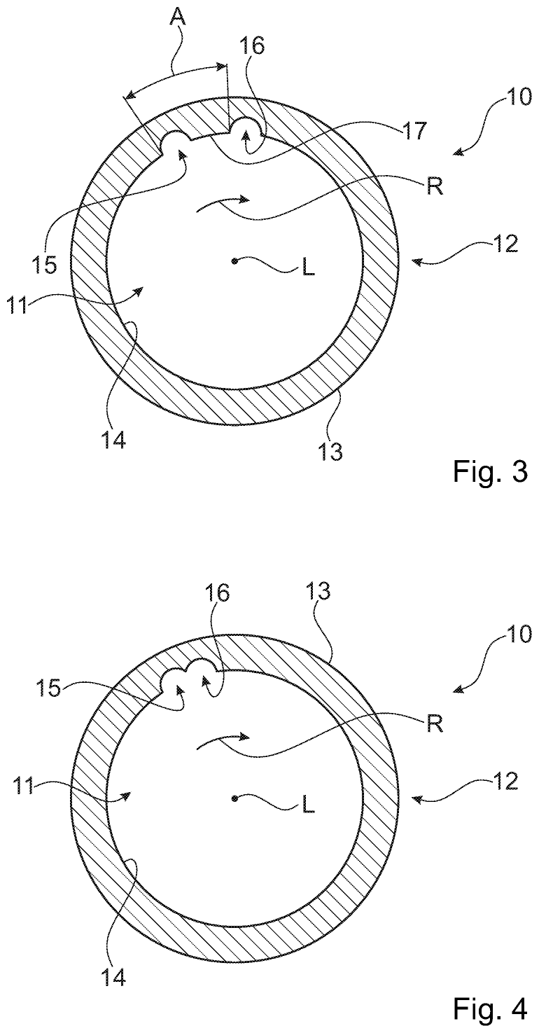

FIG. 3 shows another possible exemplary embodiment of the hollow cylindrical component 10 according to the invention. For the sake of brevity, the following discussion addresses only the differences from the exemplary embodiment in FIG. 2. In addition to the line receptacle 15, the hollow cylindrical component 10 in the exemplary embodiment in FIG. 3 has a further line receptacle 16. The line receptacles 15, 16 are spaced apart from one another in a radial direction R that extends about the longitudinal axis L. The inner casing 14 is thus also present between the line receptacles 15, 16, and forms a connecting web 17 between the line receptacles 15, 16. Starting from the longitudinal axis L and extending in the radial direction R, the distance A of the line receptacles 15, 16 from one another may be at least 5°, up to 10°, up to 45°, up to 90°, up to 135°, or even up to 180°. The line receptacles 15, 16 are in particular offset in parallel to one another along the inner casing 14.

FIG. 4 shows another possible exemplary embodiment of the hollow cylindrical component 10 according to the invention. For the sake of brevity, the following discussion addresses only the differences from the exemplary embodiment in FIG. 3. In the exemplary embodiment in FIG. 4, the line receptacles 15, 16 of the hollow cylindrical component 10 at least partially overlap in the radial direction R.

The edge of each of the line receptacles 15, 16 formed by the cylinder wall 12 may have a circular or polygonal base area in the base area of the hollow cylindrical component 10. In a plane transverse to the longitudinal axis L, the edge may extend over a smaller angle than the edge in the exemplary embodiment in FIG. 3. In particular, the edge between the line receptacles 15, 16 may end before reaching the section of the inner casing 14 at a distance from the line receptacles 15, 16. The distance of the midpoints of the line receptacles 15, 16 from one another along the radial direction R is preferably smaller than the diameter of the line receptacles 15, 16 along the radial direction R, if these would not overlap.

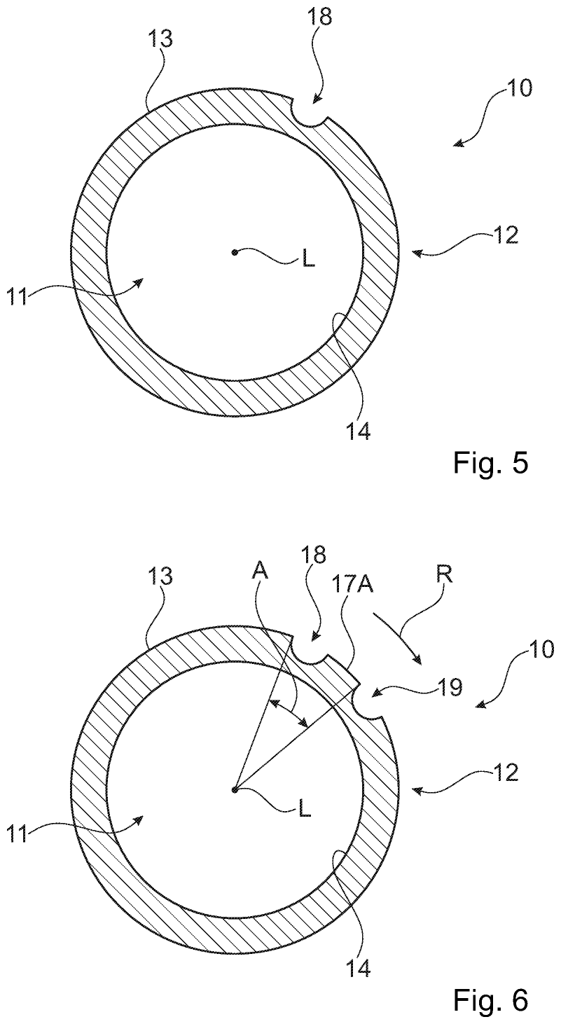

FIG. 5 shows another possible exemplary embodiment of the hollow cylindrical component 10 according to the invention. For the sake of brevity, the following discussion addresses only the differences from the preceding exemplary embodiments. The hollow cylindrical component 10 in the exemplary embodiment illustrated in FIG. 5 has a line receptacle 18 that is spaced apart from the inner casing 14. The line receptacle 18 in the exemplary embodiment in FIG. 5 penetrates the outer casing 13, at least in sections, so that the line receptacle 18 is open, at least in sections, away from the inner cavity 11 or the longitudinal axis L. As a result, a line may be easily inserted, transversely with respect to the longitudinal axis L, into the line receptacle 18, which extends along the inner casing 14 in the manner of a groove.

An edge of the line receptacle 18 formed by the cylinder wall 12 may have a circular or polygonal base area in the base area of the hollow cylindrical component 10. In a plane transverse to the longitudinal axis L, the edge may extend over at least 90°, for example up to 135°, up to 180°, or even up to 215°, about a midpoint of the circular or polygonal base area of the line receptacle 18. If the edge extends over less than 180°, a line may be easily inserted into the line receptacle 18. If the edge extends over greater than 180°, the line may be held in the line receptacle 18 in a form-fit or force-fit manner with a cross section that is essentially complementary to the cross section of the line receptacle 18.

FIG. 6 shows another possible exemplary embodiment of the hollow cylindrical component 10 according to the invention. For the sake of brevity, the following discussion addresses only the differences from the exemplary embodiment in FIG. 5. In addition to the line receptacle 18, the hollow cylindrical component 10 in the exemplary embodiment in FIG. 6 has a further line receptacle 19. The line receptacles 18, 19 are spaced apart from one another in a radial direction R that extends about the longitudinal axis L. The outer casing 13 is thus present between the line receptacles 18, 19, and forms a connecting web 17A between the line receptacles 18, 19. Starting from the longitudinal axis L and extending in the radial direction R, the distance A of the line receptacles 18, 19 from one another may be at least 5°, up to 10°, up to 45°, up to 90°, up to 135°, or even up to 180°. The line receptacles 18, 19 are in particular offset in parallel to one another along the inner casing 14.

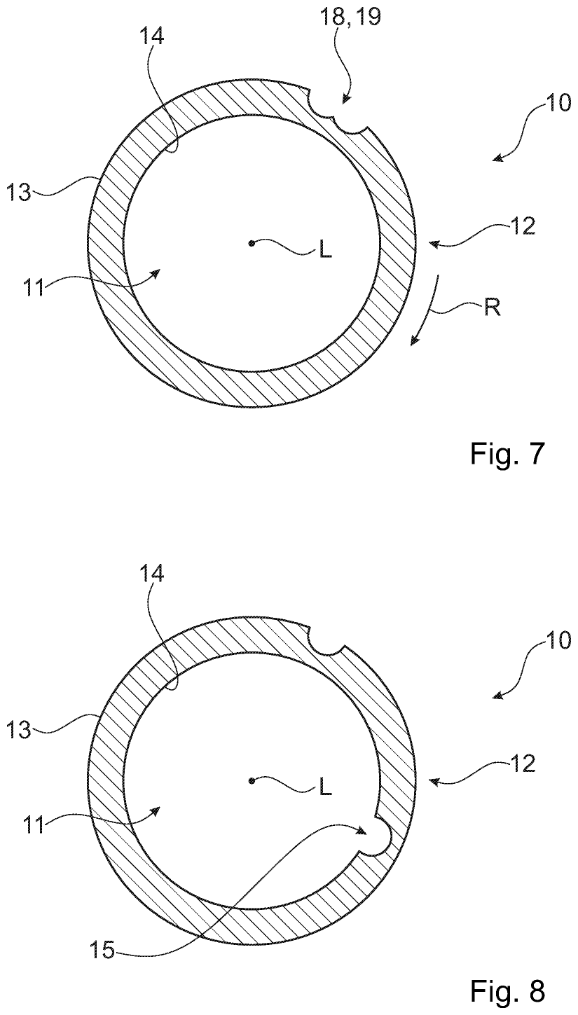

FIG. 7 shows another possible exemplary embodiment of the hollow cylindrical component 10 according to the invention. For the sake of brevity, the following discussion addresses only the differences from the exemplary embodiment in FIG. 6. In the exemplary embodiment in FIG. 7, the line receptacles 18, 19 of the hollow cylindrical component 10 at least partially overlap in the radial direction R.

The edge of each of the line receptacles 18, 19 formed by the cylinder wall 12 may have a circular or polygonal base area in the base area of the hollow cylindrical component 10. In a plane transverse to the longitudinal axis L, the edge may extend over a smaller angle than the edge in the exemplary embodiment in FIG. 7 [sic; 6]. In particular, the edge between the line receptacles 18, 19 may end before reaching the section of the outer casing 13 at a distance from the line receptacles 18, 19. The distance of the midpoints of the line receptacles 18, 19 from one another along the radial direction R is preferably smaller than the diameter of the line receptacles 18, 19 along the radial direction R, if these would not overlap.

FIG. 8 shows another possible exemplary embodiment of the hollow cylindrical component 10 according to the invention. For the sake of brevity, the following discussion addresses only the differences from the preceding exemplary embodiments. The hollow cylindrical component 10 in the exemplary embodiment illustrated in FIG. 8 has at least one line receptacle 15 and at least one line receptacle 18. If the hollow cylindrical component 10 has more than one line receptacle that is open toward the longitudinal axis L, these line receptacles 15, 16 may be formed as in at least one of the exemplary embodiments in FIGS. 3 and 4. Alternatively or additionally, if the hollow cylindrical component 10 has more than one line receptacle that is open toward the longitudinal axis L, these line receptacles 18, 19 may be formed as in at least one the exemplary embodiments in FIGS. 6 and 7.

Optionally, the hollow cylindrical component 10 in each of the exemplary embodiments in FIGS. 2 through 8 may additionally have the line receptacle 15 in the exemplary embodiment in FIG. 1.

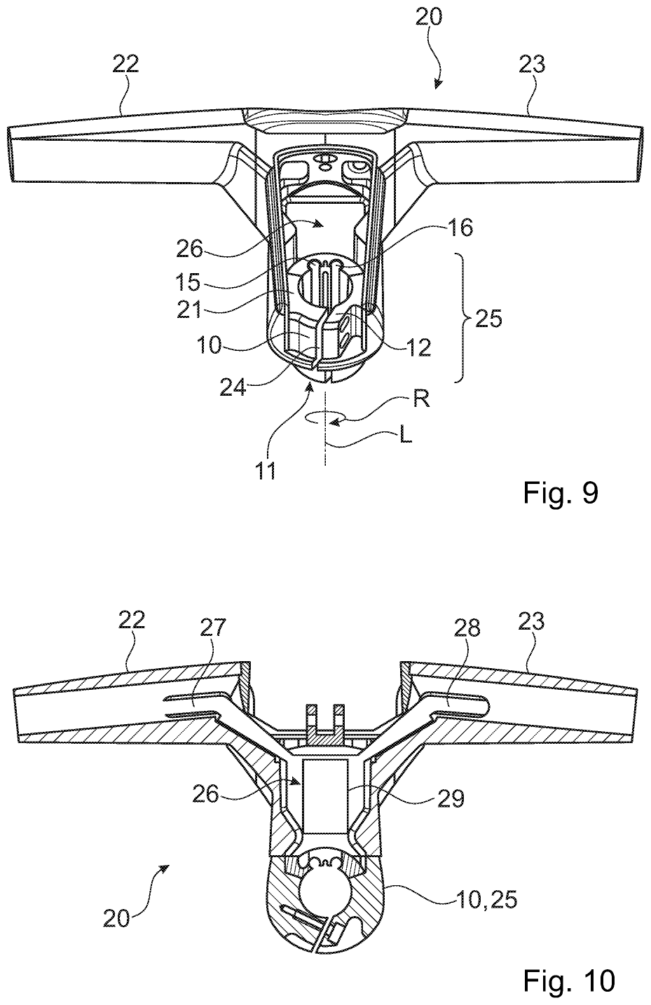

FIG. 9 shows a first exemplary embodiment of a stem 20 according to the invention for a bicycle together with the hollow cylindrical component 10. The hollow cylindrical component 10 essentially corresponds to the hollow cylindrical component 10 in the exemplary embodiment in FIG. 3. Alternatively, the stem 20 together with the hollow cylindrical components 10 may be formed [as in] the other exemplary embodiments.

FIG. 9 shows the stem 20 according to the invention in a schematic perspective illustration. The hollow cylindrical component 10 is shown as an integral part of the stem 20 strictly by way of example. Alternatively or additionally, other parts of the bicycle and in particular of the bicycle frame may cooperate with the hollow cylindrical component 10, include same, or be made up of same. These parts of the bicycle may be a tubular section of the bicycle frame and, for example, the head tube, the top tube, the down tube, the seat tube, the upper tube of the rear assembly, or the lower tube of the rear assembly of the bicycle frame. In particular, the hollow cylindrical component 10 may advantageously be used as a socket element or a clamping sleeve in the stem 20 for cable routing, where the hollow cylindrical component 10 encloses the head tube, or is enclosed by the head tube or accommodated therein.

One end of the hollow cylindrical component 10 is formed with an end-face side 21 that extends transversely with respect to the longitudinal axis L. The hollow cylindrical component 10 may also include the end-face side 21 when the former is not part of the stem 20. The end-face side 21 may at least partially extend about the longitudinal axis L. The line receptacles 15, 16 extend, for example, through the end-face side 21 along the longitudinal axis L.

The line receptacles 15, 16 curve away from the inner cavity 11 in the area of the end-face side 21. “In the area of the end-face side 21” may mean that the area extends along the longitudinal axis L from the end-face side 21 into the hollow cylindrical component 10 to a depth that corresponds at least to the diameter of the respective line receptacle 15, 16 transverse to the longitudinal axis L. The diameter is the diameter of a section of a respective line receptacle 15, 16 that does not curve away from the longitudinal axis L.

If the hollow cylindrical component 10 additionally or alternatively has at least one line receptacle 18, 19 that is open away from the longitudinal axis L, this line receptacle 18, 19 in the area of the end-face side 21 may curve toward the inner cavity 11 or toward the longitudinal axis L. “In the area of the end-face side 21” may mean that the area extends along the longitudinal axis L from the end-face side 21 into the hollow cylindrical component 10 to a depth that corresponds at least to the diameter of the respective line receptacle 18, 19 transverse to the longitudinal axis L. The diameter is the diameter of a section of a respective line receptacle 18, 19 that does not curve away from the longitudinal axis L.

In addition, if the hollow cylindrical component 10 has only one line receptacle 15, it may have a design in the area of the end-face side 21 that curves away from the longitudinal axis L. However, if the hollow cylindrical component 10 has multiple, in particular two, line receptacles 15, 16, they may curve away from one another in the area of the end-face side 21, as illustrated in the exemplary embodiment in FIG. 9.

Even if the hollow cylindrical component 10 additionally or alternatively has only one line receptacle 18, it may be curved toward the longitudinal axis L in the area of the end-face side 21. However, if the hollow cylindrical component 10 additionally or alternatively has multiple, in particular two, line receptacles 18, 19, they may curve toward one another in the area of the end-face side 21.

If the hollow cylindrical component 10 is part of the stem 20, and the stem 20 has handlebar connecting pieces 22, 23 for connecting the stem 20 to handlebar grips for the bicycle, each of the line receptacles 15, 16 in the area of the end-face side 21 may extend toward the respective handlebar connecting piece 22, 23.

In the exemplary embodiment in FIG. 9, the hollow cylindrical component 10 has a slot 24 that extends through the cylinder wall 12 on one side of the longitudinal axis L. The slot 24 may extend in parallel to the longitudinal axis L or at an angle to the longitudinal axis L. The hollow cylindrical component 10 may thus form at least one section of a tube receptacle 25. The tube receptacle 25 is formed for the clamping accommodation of a tube, in particular a steerer tube or a seat tube, or as a further alternative, as a crankshaft or some other drive shaft. The inner cavity 11 may be formed, at least in sections, in a receptacle in the tube.

For example, the tube may be inserted into the inner cavity 11 in a receiving direction that extends along the longitudinal axis L. The slot 24 may be compressed along the radial direction R in order to hold the tube with clamping in the hollow cylindrical component 10.

Viewed from the longitudinal axis L behind the line receptacles 15, 16, the stem 20 in the exemplary embodiment in FIG. 9 has a cavity 26. The cavity 26 may be used to accommodate an electronic component. The at least one line receptacle 15 or the two line receptacles 15, 16 illustrated in the exemplary embodiment in FIG. 9 open(s) into this cavity 26.

FIG. 10 shows the exemplary embodiment from FIG. 9 in a schematic sectional view, with the section plane extending essentially transversely with respect to the longitudinal axis L. The stem 20 is shown together with the hollow cylindrical component 10, which is designed as a tube receptacle 25, and the two handlebar connecting pieces 22, 23 that are mounted on the tube receptacle 25. At least one of the handlebar connecting pieces 22, 23, in particular both handlebar connecting pieces 22, 23, are in each case designed with at least one line guide 27, 28 that is situated, at least in sections, inside the respective handlebar connecting piece 22, 23. The at least one line guide 27, 28 is designed for accommodating lines and guiding them toward the line receptacles 15, 16 or into the cavity 26. For example, the line guides 27, 28 open into the cavity 26. The openings in the line receptacles 15, 16 may each be curved toward at least one of the line guides 27, 28, in particular toward the openings thereof into the cavity 26.

The cavity 26 is preferably situated, at least in sections, between the opening in the at least one line receptacle 15 or the openings in the two line receptacles 15, 16, and the opening in the at least one line guide 27 or the openings in the line guide 27, 28. An electronic component 29 may be situated in the cavity 26.

The electronic component 29 may be designed for connecting lines, guided through the line guide 27 or through the line guides 27, 28 into the cavity 26, to a line accommodated in the at least one line receptacle 15 or lines accommodated in the line receptacles 15, 16, in a signal-transmitting manner. In particular, the electronic component 29 may be a signal distribution device for distributing control signals. The electronic component 29 may process the control signals before they are relayed. Alternatively, the electronic component 29 may relay control signals of multiple lines in combination to a single line or distributed on different lines.

FIG. 11 shows a schematic view of a bicycle 30, having a hollow cylindrical component 10 as part of the stem 20 of the bicycle 30. Alternatively or additionally, at least one component of the bicycle frame 31, such as its top tube 32, its down tube 33, its seat tube 34, the upper tube 35 of its rear assembly 36, or the lower tube 37 of its rear assembly 36, may include the hollow cylindrical component 10 or may even be completely made up of same, at least in sections. The bicycle 30 may be a bicycle that is drivable solely by electrical power, solely by muscle power, or selectively by either electrical power or muscle power. In addition, the bicycle 30 may be an electric motorcycle, or also a pedelec or E-bike.

In each of the preceding embodiments, the hollow cylindrical component 10, the stem 20, and/or the bicycle 30 may have at least one, two, three, five, or up to 10, i.e., multiple or any desired number of, line receptacles, of which at least some are at least partially situated inside the cylinder wall.

### LIST OF REFERENCE SYMBOLS

10 hollow cylindrical component
11 inner cavity
12 cylinder wall
13 outer casing
14 inner casing
15, 16 line receptacle
17 web
20 stem
21 end-face side
22, 23 handlebar connecting pieces
24 slot
25 tube receptacle
26 cavity
27, 28 line guide
29 electronic component
30 bicycle
31 bicycle frame
32 top tube
33 down tube
34 seat tube
35 upper tube
36 rear assembly
37 lower tube
A distance
L longitudinal axis
R radial direction

1. A hollow cylindrical component for a bicycle, having a cylinder wall that separates the inner cavity of the hollow cylindrical component from the surroundings of the hollow cylindrical component,
wherein
the hollow cylindrical component has at least one line receptacle that extends, at least in sections, along the longitudinal axis of the hollow cylindrical component and that is at least partially situated in the cylinder wall.

2. The hollow cylindrical component according to claim 1, wherein the at least one line receptacle is spaced apart from the outer casing of the hollow cylindrical component.

3. The hollow cylindrical component according to claim 1, wherein the at least one line receptacle, at least in sections, is open toward the inner cavity.

4. The hollow cylindrical component according to claim 1, wherein the at least one line receptacle extends through an end-face side of the hollow cylindrical component.

5. The hollow cylindrical component according to claim 4, wherein in the area of the end-face side the at least one line receptacle curves away from the inner cavity.

6. The hollow cylindrical component according to claim 1, wherein the hollow cylindrical component has multiple line receptacles that are offset in parallel to one another, at least in sections.

7. The hollow cylindrical component according to claim 1, wherein the hollow cylindrical component has multiple line receptacles that are curved away from one another in the area of the end-face side.

8. A stem for a bicycle, having a hollow cylindrical component with a cylinder wall that separates the inner cavity of the hollow cylindrical component from the surroundings of the hollow cylindrical component, wherein the hollow cylindrical component has at least one line receptacle that extends, at least in sections, along the longitudinal axis of the hollow cylindrical component and that is at least partially situated in the cylinder wall.

9. The stem according to claim 8, wherein the stem has a tube receptacle for the clamping accommodation of a steerer tube, wherein the hollow cylindrical component forms at least one section of the tube receptacle, and the inner cavity is designed to accommodate at least one section of the steerer tube.

10. The stem according to claim 9, wherein the tube receptacle is designed to accommodate the steerer tube in a receiving direction, and the at least one line receptacle extends, at least in sections, along the receiving direction.

11. The stem according to claim 9, wherein the stem has a cavity for accommodating an electronic component, with the at least one line receptacle opening into the cavity.

12. The stem according to claim 11, wherein the stem has two handlebar connecting pieces for connection to handlebar grips for the bicycle, wherein at least one of the handlebar connecting pieces is designed with at least one line guide that is situated, at least in sections, inside the handlebar connecting piece, and wherein the line guide opens into the cavity.

13. The stem according to claim 12, wherein the cavity, at least in sections, is situated between the opening in the at least one line receptacle and the opening in the at least one line guide.

14. The stem according to claim 11, wherein an electronic component is situated in the cavity, the electronic component being a signal distribution device for distributing electrical control signals of a bicycle that is at least partially electrically operable or drivable.

15. A bicycle, comprising:
a hollow cylindrical component with a cylinder wall that separates the inner cavity of the hollow cylindrical component from the surroundings of the hollow cylindrical component, wherein the hollow cylindrical component has at least one line receptacle that extends, at least in sections, along the longitudinal axis of the hollow cylindrical component and that is at least partially situated in the cylinder wall.

16. The bicycle according to claim 15, wherein the bicycle has a bicycle frame with at least one tubular section, wherein the hollow cylindrical component is at least partially situated in the tubular section or forms same.

17. The bicycle according to claim 15, comprising a stem having the hollow cylindrical component.

18. The bicycle according to claim 17, wherein the stem has a tube receptacle or the clamping accommodation of a steerer tube, wherein the hollow cylindrical component forms at least one section of the tube receptacle, and the inner cavity is designed to accommodate at least one section of the steerer tube.

19. The bicycle according to claim 17, wherein the stem has a cavity for accommodating an electronic component, with the at least one line receptacle opening into the cavity.

20. The stem according to claim 19, wherein an electronic component is situated in the cavity, the electronic component being a signal distribution device for distributing electrical control signals of the bicycle that is at least partially electrically operable or drivable.
